(19) United States
(12) Patent Application Publication
(10) Pub. No.: US 2026/0138394 A1
(43) Pub. Date: May 21, 2026

(54) WHEEL BEARING ASSEMBLY

(71) Applicant: Volkswagen Aktiengesellschaft, Wolfsburg (DE)

(72) Inventor: Gregor Schaaf, Wolfsburg (DE)

(21) Appl. No.: 19/397,256

(22) Filed: Nov. 21, 2025

(30) Foreign Application Priority Data
Nov. 21, 2024 (DE) 102024134324.9

(51) Int. Cl. B60B 27/00

(52) U.S. Cl. CPC B60B 27/0031; B60B 27/0005; B60B 2380/12; B60B 2380/73; B60B 2900/133

(57) ABSTRACT

A wheel bearing assembly includes a wheel hub having inner teeth, a wheel bearing arranged at the wheel hub, and a constant velocity joint having an axle journal with outer teeth engaged with the inner teeth for torque transmission. A clamping device axially clamps the wheel hub and the wheel bearing against the constant velocity joint so that a bearing inner ring bears against a contact shoulder of the constant velocity joint. A metallic, uncoated friction ring is positioned between the bearing inner ring and the contact shoulder. The friction ring provides a coefficient of sliding friction that is at least 80 percent of a coefficient of static friction for both the bearing inner ring–to–friction ring interface and the friction ring–to–contact shoulder interface.

### RELATED APPLICATIONS

The present application claims priority to German Patent App. No. 102024134324.9, to Gregor Schaaf, filed November 21, 2024, the contents of which is incorporated by reference in its entirety herein.

### TECHNICAL FIELD

The present disclosure relates to a wheel bearing assembly comprising a wheel hub having inner teeth, a wheel bearing arranged at the wheel hub, and a constant velocity joint comprising an axle journal. The axle journal has outer teeth that engage with the inner teeth of the wheel hub for torque transmission. The assembly further includes a clamping device by way of which the wheel hub, including the wheel bearing, is axially clamped against the constant velocity joint so that a bearing inner ring of the wheel bearing is pressed against a contact shoulder of the constant velocity joint.

### BACKGROUND

Wheel bearing assemblies of this general type are known, for example, from EP 3964726 B1. In such configurations, the axle journal of a constant velocity joint of a drive shaft is clamped against the wheel hub, for example by means of a screw assembly. The inner ring of the wheel bearing lies in the power flow of the axial preload force. The preload force must be selected such that the bearing inner ring is reliably held in position at all times.

It is also known to fasten the inner ring of the wheel bearing to the wheel hub using roll rivets. In such configurations, a portion of the wheel hub is supported directly on the constant velocity joint. The bearing inner ring is therefore not located in the power flow of the preload force. As a result, lower axial preload forces can be selected when fixing the constant velocity joint to the wheel hub.

In principle, the screw assembly can be provided on a “short axle journal” by threading a fastening bolt, serving as a clamping device, into the end face of the axle journal, as shown for example in FIG. 1 of EP 3 964 726 B1. Such a design has conventionally been used only when the wheel bearing lies in the power flow of the preload force.

For roll-riveted wheel hubs, by contrast, a “long axle journal” is typically used. Such a long axle journal includes an external thread section at its end, onto which a nut serving as the clamping device is threaded.

During intended operation, torque transmission between the constant velocity joint and the wheel hub occurs via the inner and outer teeth on the wheel hub and the axle journal. Due to the axial clamping described above, however, a portion of the torque is also transmitted frictionally at the shoulder surface of the axle journal. If the torque exceeds the static friction at this interface, sudden small relative movement may occur between the shoulder and the corresponding counter surface. Such relative movement can result from elasticity and/or play within the toothing engagement. The resulting noise is commonly referred to as clacking noise during start-up or “ping noise.”

If such slippage also occurs in the opposite torque direction - for example, when reversing or due to coasting moments such as those present during recuperation in electrically driven vehicles - undesirable noise can arise repeatedly. Trends toward higher wheel torques, larger wheels, increased engine torque, and recuperation operation in electric vehicles exacerbate this problem, which is increasingly difficult to control using conventional measures.

EP 3 964 726 B1 describes several approaches that have been used to address this issue:

A first approach is to significantly increase the friction at the contact shoulder so that slippage does not occur. EP 3 964 726 B1 mentions the use of very rough, oil-free surfaces or intermediate layers made of diamond fleece or diamond discs. In practice, however, it is often difficult to prevent torque levels from exceeding static friction. The associated drop in torque in such events is considerable. The high coefficient of friction also results in increased wear at the contact shoulder. This is particularly problematic in recuperation mode for short axle journals, since increased wear leads to a reduction in preload force at the wheel bearing, which may ultimately compromise the security of the screw assembly.

A second approach is to reduce the friction at the contact shoulder to such an extent that no noise occurs during slipping. This can be achieved using friction-reducing sliding discs as intermediate layers, as proposed for example in EP 1 526 297 A1, EP 2 263 887 A1, and JP 2003 097588 A. Reducing friction lowers the proportion of torque transmitted via the shoulder of the constant velocity joint. Consequently, more torque must be transmitted through the inner and outer teeth between the wheel hub and the axle journal, requiring reinforcement of these components. This reinforcement may involve a more solid design of the axle journal with a larger diameter and/or increased axial length of the toothing engagement. Both measures increase structural space requirements and component weight, which is undesirable.

Long axle journals are generally preferred, since unlike short axle journals, they can be manufactured from solid material and thus remain more compact. The use of roll-riveted wheel bearings also reduces demands on screw joint reliability. The axial force can be reduced because the wheel bearing does not require a high preload, which may also reduce torque drop during slippage and thus noise generation. This can allow the use of coated sliding discs. However, sliding discs are not a satisfactory solution for short axle journals under variable torsional loads, since a significantly higher axial preload is required in such cases.

A third approach is to design a backlash-free spline connection between the wheel hub and the axle journal so that no loosening or striking of components can occur. This may be achieved, for example, by adhesive bonding - although this introduces additional assembly and service complexity - or by pressing the teeth into engagement. EP 3 964 726 B1 proposes a specific tooth geometry to achieve high pressing while still allowing the components to be joined manually, without supplemental pressing equipment, in the context of economical mass production. However, even with this approach, high recuperation torque may still lead to undesirable noise.

### SUMMARY

Some aspects of the present disclosure are directed to identifying configurations that reduce or avoid undesirable noise under high and variable torsional loads and under high axial clamping forces in a wheel bearing assembly.

In some examples, a wheel bearing assembly is provided comprising a wheel hub having inner teeth; a wheel bearing arranged at the wheel hub; and a constant velocity joint comprising an axle journal, the axle journal having outer teeth engaged with the inner teeth of the wheel hub for torque transmission. A clamping device is provided by way of which the wheel hub, including the wheel bearing, is axially clamped against the constant velocity joint such that a bearing inner ring of the wheel bearing is pressed against a contact shoulder of the constant velocity joint. A metallic, uncoated, friction-increasing friction ring is arranged between the bearing inner ring and the contact shoulder, wherein a coefficient of sliding friction of the contact between the friction ring and the bearing inner ring, and between the friction ring and the contact shoulder, is in each case at least 80% of a coefficient of static friction.

In some examples, a metallic, uncoated, friction-increasing friction ring is arranged between the bearing inner ring and the contact shoulder of the wheel bearing assembly, wherein a coefficient of sliding friction of the contact between the friction ring and the bearing inner ring, and between the friction ring and the contact shoulder, is in each case at least 80% of a coefficient of static friction.

### BRIEF DESCRIPTION OF THE DRAWINGS

The present disclosure will be described hereafter in more detail with reference to an exemplary embodiment illustrated in the drawings. In the drawings:

FIG. 1 shows a longitudinal sectional view of a wheel bearing assembly comprising a friction ring, according to some aspects of the present disclosure.

FIG. 2 shows a view of the friction ring, according to some aspects of the present disclosure.

### DETAILED DESCRIPTION

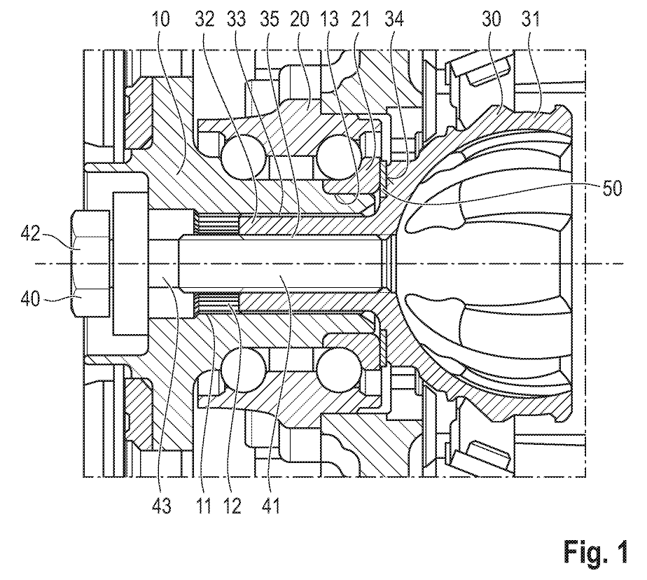

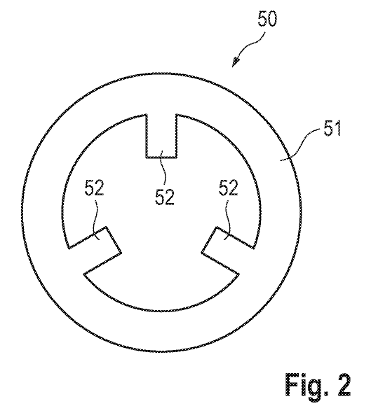

FIGS. 1 and 2 show an exemplary configuration according to some aspects of the present disclosure.

The use of a metallic, uncoated friction ring allows the wheel bearing assembly to be preloaded with high axial forces at a level that ensures sufficient screw-joint reliability, even when the wheel bearing is simultaneously subjected to axial preload.

When the sliding friction coefficient and the static friction coefficient are at a similar level, the drop in torque during the transition from static friction to sliding friction (i.e., during slippage) remains low. As a result, the proportion of torque transmitted via the contact shoulder changes only slightly, such that the additional reinforcement effort required for the inner and outer teeth remains low. This supports a compact design and is particularly advantageous in the context of short axle journals.

In addition, noise generation is reduced even under high axial preload. A characteristic “ping noise” is avoided or at least attenuated to a low-frequency clicking sound that is no longer readily perceptible.

Accordingly, the disclosed configuration is particularly suitable for vehicles having high wheel torques and/or recuperation operation, as is often the case with electric vehicles.

Certain additional examples and refinements of the present disclosure are described below.

In some examples, the coefficient of static friction is higher than the coefficient typically associated with steel-on-steel contact. For dry friction, the static friction coefficient is preferably greater than 0.15 and less than 0.30. Excessively high friction coefficients should be avoided, as they may lead to increased wear during slippage, which could result in an undesirable reduction of preload over time.

In some examples, the proportion of torque transmitted via the friction ring relative to the total torque transmitted between the wheel hub and the constant velocity joint is 20% to 40%. This torque distribution supports a compact and lightweight design and cannot be achieved using friction-reducing sliding discs. In the present context, “torque to be transmitted” refers to the maximum torque that can be transmitted to the wheel (also known as slip torque), which depends on axle load, including axle-load shifts. Dynamic effects in the drive train may cause higher transient peaks, but such peaks are not encompassed by the term “torque to be transmitted” as used herein.

In some examples, the friction ring has a tensile strength of 500 to 650 N/mm² and/or a hardness of 140 to 230 HV10. These mechanical properties enable the use of axial preload forces greater than 100 kN.

Despite the mechanical performance requirements, the friction ring can be manufactured and assembled in a straightforward manner. For example, the friction ring can be formed as a cost-effective stamped sheet-metal part.

At a thickness preferably between 0.2 mm and 2.0 mm, the friction ring contributes negligibly to the space requirements and mass of the wheel bearing assembly. As noted above, this facilitates a compact and lightweight wheel-end design in the region of the axle journal.

In some examples, the friction ring is formed from a copper alloy. A copper alloy having a tin content of 2% to 8% has proven particularly advantageous.

To facilitate assembly, the friction ring may comprise a ring section from whose inner circumference multiple lands protrude radially inward, with the friction ring extending overall in a single plane.

In some examples, the inner and outer teeth at the wheel hub and at the axle journal form a backlash-free spline connection. The clamping device may be a clamping bolt that is axially screwed into an internal thread formed at the axle journal. The bolt includes a threaded section and is supported at the wheel hub via a head section. Such a short axle journal enables an especially compact wheel bearing assembly with high torque-transmission capability, including under variable loads, while also providing favorable acoustic properties.

A backlash-free spline may be obtained, for example, by pressing the inner teeth and outer teeth together during assembly using an axial pull-in force.

The wheel bearing assembly 1 shown by way of example comprises a wheel hub 10, a wheel bearing 20 arranged at the wheel hub 10, a constant velocity joint 30 that forms part of a drive shaft, and additionally a clamping device 40 and a friction ring 50.

In some examples, the wheel bearing assembly 1 is used in passenger cars and light commercial vehicles.

In the present example, the wheel hub 10 comprises a through-opening 11 having inner teeth 12. The inner teeth 12 may be implemented, for example, as serrated teeth, splined teeth, toothed-shaft teeth, or similar toothing structures.

The wheel hub 10 further includes a projection 13 on its outer circumference for receiving the wheel bearing 20. The wheel bearing 20 is supported on the projection 13 via a bearing inner ring 21. As shown by way of example in FIG. 1, a portion of the bearing inner ring may alternatively be formed directly by a section of the wheel hub 10.

In the present example, the constant velocity joint 30 comprises a joint bell 31 and an axially adjoining axle journal 32. Outer teeth 33 are formed at the axle journal 32 and mesh with the inner teeth 12 of the wheel hub 10 for torque transmission.

The toothing engagement between the inner teeth 12 and the outer teeth 33 is preferably designed to be backlash-free. For example, the inner teeth 12 and outer teeth 33 may be pressed together axially to achieve such engagement.

In particular, the toothing engagement may be designed in accordance with the approaches described in EP 3964726 B1, although the present disclosure is not limited to the configurations described therein.

By way of the clamping device 40, the wheel hub 10, including the wheel bearing 20, is axially clamped against the constant velocity joint 30 such that the bearing inner ring 21 is pressed against a contact shoulder 34 of the constant velocity joint 30.

As shown by way of example in FIG. 1, the clamping device 40 may be implemented as a clamping bolt that is axially threaded into an internal thread section 35 formed at the axle journal 32. The bolt includes an external thread section 41 and engages the internal thread section 35, which may be formed at a through-opening of the constant velocity joint 30.

The clamping bolt further comprises a head section 42 that is axially supported against the wheel hub 10.

In some examples, the clamping bolt may include an expansion section 43 having a cross-section that tapers relative to the external thread section 41, transitioning into the head section 42.

Due to the internal thread section 35, the axle journal 32 shown in FIG. 1 can be referred to as a “short axle journal.” Such a short axle journal is shorter than a “long axle journal,” in which the axle journal—including the outer teeth—is typically made from solid material and additionally includes an axially attached external thread for receiving a nut as a clamping device.

The axial end face of the bearing inner ring 21 does not rest directly on the contact shoulder 34. Instead, the friction ring 50 is arranged between them such that the friction ring 50, similar to the wheel bearing 20, lies in the power flow of the axial preload force provided by the clamping device 40. Accordingly, the axial preload applied to the wheel bearing 20 is supported via the friction ring 50 on the contact shoulder 34 of the constant velocity joint 30.

As described above, the friction ring 50 is a metallic, uncoated component that increases friction relative to direct contact between the bearing inner ring 21 and the contact shoulder 34. Accordingly, the static friction coefficient between the friction ring 50 and the contact surfaces of components 21 and 34 is higher than the static friction coefficient between the bearing inner ring 21 and the contact shoulder 34 alone.

In particular, the static friction coefficient for contact involving the friction ring 50 is greater than the coefficient associated with steel-on-steel contact.

The friction ring 50 ensures that, when torque is transmitted between the constant velocity joint 30 and the wheel hub 10 (in either rotational direction), a defined proportion of the total torque is transmitted via the friction ring 50 and thus through the contact shoulder 34.

In some examples, the proportion of torque transmitted via the friction ring 50 relative to the total torque transmitted between the wheel hub 10 and the constant velocity joint 30 is 20% to 40%. Preferably, the lower limit may be greater than 25% and/or the upper limit may be less than 35%. During full-load acceleration, for example, a rear wheel of a passenger vehicle may transmit a torque of approximately 3000 Nm due to axle-load shift prior to wheel slip.

In some examples, the sliding friction coefficient for the friction pairing of friction ring 50 and contact shoulder 34, and for the pairing of friction ring 50 and the contact surface of the bearing inner ring 21, is at least 80% of the static friction coefficient associated with the respective friction pairing. The sliding friction coefficient is preferably more than 86% of the static friction coefficient and more preferably more than 90%.

In particular, the sliding friction coefficient of the friction ring 50 against steel may be at least 80% of the static friction coefficient against steel, preferably at least 86%, and more preferably more than 90%.

The static friction coefficient for dry friction is preferably greater than 0.15 and less than 0.30. Preferably, the lower limit may be greater than 0.16 or greater than 0.17, and the upper limit may be less than 0.28 or less than 0.25.

By comparison, assuming a static friction coefficient of approximately 0.15 for dry steel-on-steel contact, the corresponding sliding friction coefficient is typically around 0.12, representing at most 80% of the static friction coefficient.

In contrast, a friction ring 50 according to the present disclosure can provide, for example, a static friction coefficient of approximately 0.19 against steel and a sliding friction coefficient of approximately 0.18.

Accordingly, when using the friction ring 50, the difference between static and sliding friction is substantially smaller than in steel-on-steel contact, while the levels of both static and sliding friction are higher than those associated with steel-on-steel contact.

As a result, when the static friction is overcome, the proportion of torque transmitted via the contact shoulder 34 does not decrease significantly. Accordingly, the axle journal 32 and the meshing engagement between the wheel hub 10 and the axle journal 32 may be designed with less robustness than would be required in configurations having a larger difference between the static friction coefficient and the sliding friction coefficient, or in configurations employing a sliding disc instead of the friction ring 50. This supports a more compact and lightweight design of the wheel bearing assembly.

The reduced drop in torque also has a favorable effect on noise generated during the transition from static friction to sliding friction. A characteristic “ping noise” may no longer occur or may be attenuated to such an extent that it becomes almost imperceptible.

To support high axial forces - such as those encountered particularly with short axle journals, where the wheel bearing 20 and the friction ring 50 lie in the power flow of the axial preload force applied by the clamping device 40 - the friction ring 50 preferably has a tensile strength of 500 to 650 N/mm² and/or a hardness of 140 to 230 HV10.

These properties enable axial forces of approximately 100 to 250 kN, as may be required for preloading the wheel bearing 20, to be supported by the friction ring 50 without compromising the screw-joint reliability of the clamping device 40.

In addition, the mechanical properties of the friction ring 50 allow high wear resistance, thereby maintaining screw-joint reliability and preload throughout the service life of the wheel bearing assembly.

The friction ring 50, shown in FIG. 2 by way of example, may be produced as a stamped sheet-metal part having a thickness preferably in a range of 0.2 mm to 2.0 mm, and more preferably in the range of 0.3 mm to 0.7 mm. This enables straightforward and cost-effective production.

To facilitate assembly, the friction ring 50 may include a ring section 51 from which several lands 52 extend radially inward from the inner circumference. These lands 52 assist in holding the ring section 51 at the height between the contact shoulder 34 and the corresponding counter surface at the bearing inner ring 21 during assembly.

Preferably, the friction ring 50 extends entirely in one plane, forming a flat, disc-shaped component.

In some examples, the friction ring 50 is made from a copper alloy, preferably having a tin content of 2% to 8%. Additional coatings or surface treatments on the rolled sheet metal are unnecessary.

As a non-limiting example, rolled sheet metal made of CuSn6 H180 with a sheet thickness of 0.5 mm may be used.

In a modification of the illustrated configuration, a friction ring 50 of the type described above may also be used in conjunction with a long axle journal and/or with a roll-riveted wheel bearing. In the case of a roll-riveted wheel bearing, the friction ring 50 does not rest against a bearing inner ring of the wheel bearing 20, but instead bears against a wall section of the wheel hub 10.

The present disclosure has been described above in detail with reference to an exemplary embodiment and various modifications. Individual technical features described in connection with certain examples may be implemented independently of those examples or in combination with other features, provided such implementations are technically feasible. The present disclosure is therefore not limited to the specific exemplary embodiments and modifications described herein, but encompasses all configurations defined by the claims.

### LIST OF REFERENCE SIGNS

1 wheel bearing assembly

10 wheel hub

11 through-opening

12 inner teeth

13 projection

20 wheel bearing

21 bearing inner ring

30 constant velocity joint

31 joint bell

32 axle journal

33 outer teeth

34 contact shoulder

35 internal thread section

40 clamping device

41 external thread section

42 head section

43 expansion section

50 friction ring

51 ring section

52 land

Claims:

1. A wheel bearing assembly comprising:
a wheel hub comprising inner teeth;
a wheel bearing arranged at the wheel hub, the wheel bearing comprising a bearing inner ring;
a constant velocity joint comprising an axle journal, outer teeth being formed at the axle journal and engaged with the inner teeth of the wheel hub for torque transmission;
a clamping device configured to axially clamp the wheel hub, including the wheel bearing, against the constant velocity joint such that the bearing inner ring is pressed against a contact shoulder of the constant velocity joint; and
a metallic, uncoated friction ring arranged between the bearing inner ring and the contact shoulder,
wherein a coefficient of sliding friction associated with a contact between the friction ring and the bearing inner ring, and a coefficient of sliding friction associated with a contact between the friction ring and the contact shoulder, are each at least eighty percent of a coefficient of static friction associated with the respective contact.

2. The wheel bearing assembly of claim 1, wherein a coefficient of static friction for dry friction associated with the friction ring is greater than 0.15 and less than 0.30.

3. The wheel bearing assembly of claim 1, wherein a proportion of torque transmitted via the friction ring relative to a total torque transmitted between the wheel hub and the constant velocity joint is between twenty percent and forty percent.

4. The wheel bearing assembly of claim 1, wherein the friction ring is characterized by a tensile strength between 500 N/mm² and 650 N/mm².

5. The wheel bearing assembly of claim 1, wherein the friction ring is characterized by a hardness between 140 HV10 and 230 HV10.

6. The wheel bearing assembly of claim 1, wherein the friction ring comprises a sheet-metal stamped structure.

7. The wheel bearing assembly of claim 1, wherein the friction ring comprises a thickness between 0.2 mm and 2.0 mm.

8. The wheel bearing assembly of claim 1, wherein the friction ring comprises a copper alloy.

9. The wheel bearing assembly of claim 8, wherein the copper alloy comprises a tin content between two percent and eight percent.

10. The wheel bearing assembly of claim 1, wherein the friction ring comprises a ring section from which a plurality of lands protrude radially inward from an inner circumference of the ring section, and wherein the friction ring extends in a single plane.

11. The wheel bearing assembly of claim 1, wherein the inner teeth of the wheel hub and the outer teeth of the axle journal form a backlash-free spline.

12. The wheel bearing assembly of claim 1, wherein the clamping device comprises a clamping bolt that is axially threaded into an internal thread section formed at the axle journal, the clamping bolt comprising an external thread section and a head section supported at the wheel hub.

13. A vehicle, comprising a wheel bearing assembly, the wheel bearing assembly comprising:
a wheel hub comprising inner teeth;
a wheel bearing arranged at the wheel hub, the wheel bearing comprising a bearing inner ring;
a constant velocity joint comprising an axle journal, outer teeth being formed at the axle journal and engaged with the inner teeth of the wheel hub for torque transmission;
a clamping device configured to axially clamp the wheel hub, including the wheel bearing, against the constant velocity joint such that the bearing inner ring is pressed against a contact shoulder of the constant velocity joint; and
a metallic, uncoated friction ring arranged between the bearing inner ring and the contact shoulder,
wherein a coefficient of sliding friction associated with a contact between the friction ring and the bearing inner ring, and a coefficient of sliding friction associated with a contact between the friction ring and the contact shoulder, are each at least eighty percent of a coefficient of static friction associated with the respective contact.

14. The vehicle of claim 13, wherein a coefficient of static friction for dry friction between the friction ring and steel is greater than 0.15 and less than 0.30.

15. The vehicle of claim 13, wherein a proportion of torque transmitted via the friction ring relative to a total torque transmitted between the wheel hub and the constant velocity joint is between twenty percent and forty percent.

16. The vehicle of claim 13, wherein the friction ring comprises a tensile strength between 500 N/mm² and 650 N/mm².

17. The vehicle of claim 13, wherein the friction ring comprises a sheet-metal stamped part.

18. The vehicle of claim 13, wherein the friction ring comprises a copper alloy.

19. The vehicle of claim 18, wherein the copper alloy comprises a tin content between two percent and eight percent.

20. A wheel bearing assembly comprising:
a wheel hub comprising inner teeth;
a wheel bearing arranged at the wheel hub, the wheel bearing comprising a bearing inner ring;
a constant velocity joint comprising an axle journal, outer teeth being formed at the axle journal and engaged with the inner teeth of the wheel hub for torque transmission;
a clamping device configured to axially clamp the wheel hub, including the wheel bearing, against the constant velocity joint such that the bearing inner ring is pressed against a contact shoulder of the constant velocity joint; and
a metallic, uncoated friction ring arranged between the bearing inner ring and the contact shoulder,
wherein a coefficient of sliding friction associated with a contact between the friction ring and the bearing inner ring, and a coefficient of sliding friction associated with a contact between the friction ring and the contact shoulder, are each at least eighty percent of a coefficient of static friction associated with the respective contact,
and wherein the friction ring comprises a tensile strength between 500 N/mm² and 650 N/mm².
